(19) United States
(12) Patent Application Publication
(10) Pub. No.: US 2012/0118388 A1
(43) Pub. Date: May 17, 2012

(54) System for Eliminating the Need for Watertight Manholes in Insulated Piping Installations

(76) Inventor: Thomas Joseph Keyes, Fort Worth, TX (US)

(21) Appl. No.: 13/290,414

(22) Filed: Nov. 7, 2011

Related U.S. Application Data
(60) Provisional application No. 61/412,501, filed on Nov. 11, 2010.

(51) Int. Cl. F17D 1/00; F16K 24/00

(52) U.S. Cl. 137/1; 137/583

(57) ABSTRACT

A system is shown which can replace the need for a traditional watertight manhole servicing a pre-insulated pipeline. The piping in the system is pre-insulated, as with a bonded foam insulation. The valves and fittings in the piping system are brought to a convenient height above the watertable in an excavated area in the surrounding earthen formation and are also pre-insulated. The pre-insulated valves and fittings are partially enclosed by a containment structure which keeps the surrounding earthen formation in place. Because the valves, fittings and piping are pre-insulated, it is not necessary to maintain the surrounding enclosure in a watertight condition as was the case with a traditional manhole.

### CROSS REFERENCE TO RELATED APPLICATION

The present application claims priority from the earlier filed provisional application Ser. No. 61/412,501, filed Nov. 11, 2010, with the same title as the instant application and by the same inventor.

### BACKGROUND OF THE INVENTION

1. Field of the Invention

The present invention relates to foam bonded pre-insulated piping systems, and more specifically to an installation technique for such systems, including valve locations, which eliminates the need for watertight manholes as used in the past.

2. Description of the Prior Art

There are many instances in which insulated pipelines are needed. For example, distributed HVAC (heating, ventilation and air conditioning) applications utilize chilled water for cooling and steam for heating. The chiller and boiler are typically contained in a central location and the chilled water and steam are distributed to other locations. This type of system is commonly used in large institutional setting, such as on a school campus, in a hospital complex, on a military base, and the like. The chilled water and steam are distributed to locations in separate buildings by means of insulated pipelines. For example, one set of insulated pipelines is used to carry the steam from the boiler to the other locations and back to the boiler. The insulated pipelines are oftentimes buried underground.

One particular type of insulated pipe which is used in such installations is a conventional and commercially available “pre-insulated piping.” There are predominately two types of pre-insulated piping systems in use: Class-A drainable dryable testable (DDT); and polyurethane or polyisocyanurate bonded foam systems. The present application has particular applicability for the bonded foam type system. These systems utilize a steel pipe to convey fluid. Around the outside of the steel pipe is a layer of insulating foam such as, for example, polyisocyanurate foam. Around the outside of the foam is a jacket of hard thermoplastic (such as high density polyethylene, HDPE). The plastic jacket protects the foam from mechanical damage and also provides a water tight seal to prevent corrosion of the steel pipe. Although steel is commonly used for the inner pipe which carries the media to be piped, copper or aluminum or other metals as well as fiberglass, PVC, and similar materials may be utilized, as well.

Manhole structures provide access to underground facilities, including insulated pipelines of the type under consideration, for the purposes of repair, cleaning, maintenance and inspection. For convenience, manholes are usually placed at frequent intervals along such pipelines. In addition, manholes often provide a junction point for two or more intersecting pipelines. The manhole location also provides a convenient point of access for valves and fittings of the type present in most high temperature fluid conveyance systems. These valves and fittings must be accessed from time to time and sometime require welding or other types of maintenance to be performed in the confines of the manhole.

Standard manholes have a wide cost range but a typical installation can cost on the order of $30,000.00 to over $60,000.00, including piping, valves, insulation, etc.

There are numerous problems associated with present manhole technology, many of which relate to the intrusion of environmental factors, such as the intrusion of rain water or ground water. Concrete manholes, for example, are constantly exposed to eroding, oxidizing and corrosive elements associated with the soil on the outside of the manhole and to the effects of periodic flooding. They are also prone to leaks at the point at which the pipes connect to the manhole.

Various techniques have been devised in an attempt to prevent water from entering into the interior of the manhole structure through the region of the manhole cover, through leaks in the pipe entry points, or through cracks in the walls of the manhole and the like. However, due to such forces as natural erosion and deterioration of the concrete, surface water eventually seeps through the above-mentioned regions to enter into the interior of the manhole structure. This problem is exacerbated during periods of flooding and high water due to prolonged or heavy rainfall. This problem is intensified in both urban and suburban areas where increased construction activity has resulted in large quantities of concrete being poured to construct parking lots, as well as foundations and other structures. This increase in non-permeable construction material reduces the amount of surface area which is available to absorb rainfall and increases the flow of water in storm drains, diversion canals, natural streams and other channels which must accept and dispose of the increased flow of water.

Where water enters and floods the typical prior art manhole, the uninsulated valve components are often damages. There is an inevitable loss of energy in the system. This is often apparent, even to the casual observer, of a traditional manhole “blowing steam.”

Thus, despite the various advances in the art, a need continues to exist for alternative installation procedures and structures to replace the traditional water tight manhole of the past which alternative installation eliminates many of the problems associated with manhole leakage and boiling of water flooded manholes.

The new installation should accommodate pre-insulated piping, such as a piping system for high temperature fluids such as insulated steam line, and particularly the valves and fittings used in such systems.

A need also exists for such an installation system which utilizes many of the conventionally available materials and manufacturing techniques commonly used in the industry. A need also exists for such a system which is relatively simple in design and economical to implement and which will replace the need for after-the-fact field insulation of such systems.

### SUMMARY OF THE INVENTION

The present invention has as its general object to provide a system for eliminating the need for watertight manholes in a pre-insulated piping system which satisfies many of the previously described deficiencies in the prior art systems.

Another object of the invention is to eliminate the concept of a watertight manhole while replacing it with a buried, shallow and more accessible valve and trap, i.e., low point drip station.

Another object of the invention is to eliminate the need for field insulation for valve components in the improved valve station of the invention.

The system of the invention can be used to eliminate watertight manholes in a pre-insulated piping system made up of lengths of high temperature insulated piping buried in a surrounding earthen formation. The pre-insulated piping system is made up of a plurality of lengths of pre-insulated piping sealingly connected in a pipeline to form a continuous fluid conduit for conveying high temperature fluids. The piping system also has a valve location in the pipeline containing at least one valve components located at a given height relative to a surrounding grade level, the valve location with its at least one valve component also being pre-insulated. A previously formed containment structure is arranged about the valve location to hold the surrounding earthen formation in place away from the valve component. The containment structure will typically be provided with an initially open top to allow access to an interior thereof and an open bottom. The containment structure can also be provided with a removable cover for the open top thereof.

The lengths of high temperature insulated piping which make up the piping system each preferably include a first and second length of inner metal carrier pipe, each having an inner end and an opposite, outwardly extending end. The first and second lengths of metal pipe are surrounded by an envelope of bonded foamed insulation. The foamed insulated is, in turn, surrounded by an outer protective jacket, and wherein the outwardly extending end of each of the first and second lengths of metal carrier pipe projects beyond an end of the envelope of insulation and beyond an end of the jacket to form an exposed, joining end. The joining ends of the inner pipes are sealingly connected in the piping string to form the continuous fluid conduit for conveying high temperature fluids. The joints of pipe containing the factory pre-insulated valve components can be installed in a run of the traditional, pre-insulated piping.

In one particularly preferred piping system, the foam insulation is selected from the group consisting of polyurethane foams and polyisocyanurate foam and the outer protective jackets are formed from a synthetic polyolefin. The lengths of insulated piping being joined are part of a pipeline conveying steam, hot water or other hot fluids.

Preferably, the height of the valve component is selected, relative to the surrounding grade level, so that the valve component is above a water table level for the surrounding earthen formation but at a convenient height for a maintenance worker to access. In the preferred installations of the invention, the piping installation includes, in addition to a steam line conveying steam, a condensate line for draining steam condensate, the condensate line having a below grade drip tee incorporated therein. The condensate line and drip tee are also pre-insulated.

By utilizing the top of an expansion loop in the piping system (area of no movement), the contractor locate factory pre-insulated valves and drip tees in a desired location and at a desired height relative to the surrounding grade. The valve location can be covered with a containment structure so as to enclose the valve components. This station location can be in a straight run of pipe with an anchor being located within a few feet to keep it stationary. The containment structure can be back filled, e.g., to about 4 inches above the top of the jacket with the trap and valve stems above grade for accessibility. These techniques create a man safe service/observation area. The containment structure can be provided with a variety of lid configurations, such as for example a hinged light weight aluminum cover. The cost of the improved installation of the invention is easily half the cost of a standard pour-in-place or premanufactured manhole and requires less maintenance. Additionally, one manufacturer can provide the entire system. Having all of the components pre-insulated keeps the system components water tight to increase the efficiency and longevity of the system.

The installed system is characterized as follows:
1. All components of the distribution system are pre insulated and buried creating a watertight system throughout.
2. Vastly reduces the maintenance and safety issues associated with traditional manholes.
3. One manufacturer for the entire distribution system.
4. Reducing installation costs as well as maintenance and operation costs.

Additional objects, features and advantages will be apparent in the written description which follows.

### BRIEF DESCRIPTION OF THE DRAWINGS

FIG. 1 is a perspective view of a pre-insulated piping installation of the type used in the installation system of the invention.

FIG. 2 is an isolated view of a cast culvert which is set on end and used to partly enclose the pre-insulated piping of FIG. 1.

FIG. 3 is a view of the cast culvert being lowered into position on the pre-insulated piping installation of FIG. 1.

FIG. 4 shows the culvert of FIG. 2 in place on the pre-insulated piping system of FIG. 1.

FIG. 5 is a side, partial cross-sectional elevational view of the steam line used in the pre-insulated piping system of FIG. 1.

FIG. 6 is a view similar to FIG. 5, but showing the condensate line used in the pre-insulated piping system of FIG. 1.

FIGS. 7 and 8 are views of prior art above ground valve stations of the type used with insulated steam lines.

FIG. 9 is a view of a prior art manhole on an urban street showing the manhole blowing boiling steam after being flooded with water.

### DETAILED DESCRIPTION OF THE INVENTION

As discussed briefly under the Background of the Invention, there are numerous problems associated with present manhole technology, where the manhole provides access to valves and fittings in steam lines and the like, and where insulated pipelines intersect the manhole. Many of the problems are tied to the intrusion of rain water or ground water. Concrete manholes, for example, are also constantly exposed to eroding, oxidizing and corrosive elements associated with the surrounding environment. Even though various techniques have been developed in an attempt to make the manhole “watertight” and impervious to the intrusion of water, it seems inevitable that water will continue to enter the interior of the manhole through the region of the manhole cover, through leaks in the pipe entry points, or through cracks in the walls of the manhole and the like. These problems are all exacerbated during periods of flooding and high water due to prolonged or heavy rainfall.

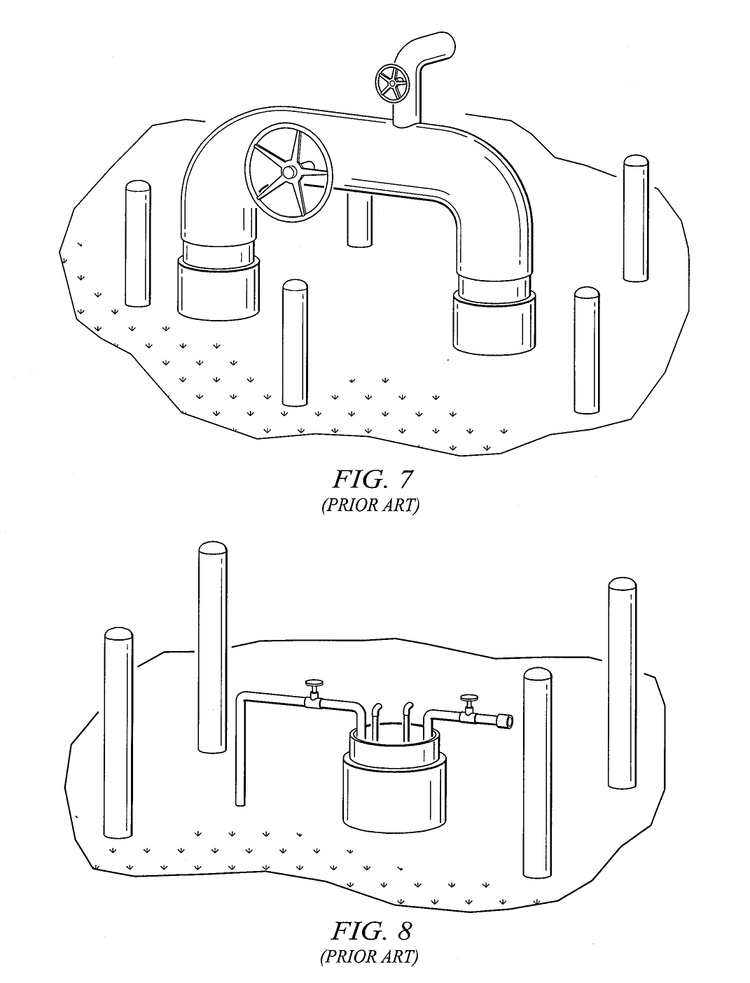

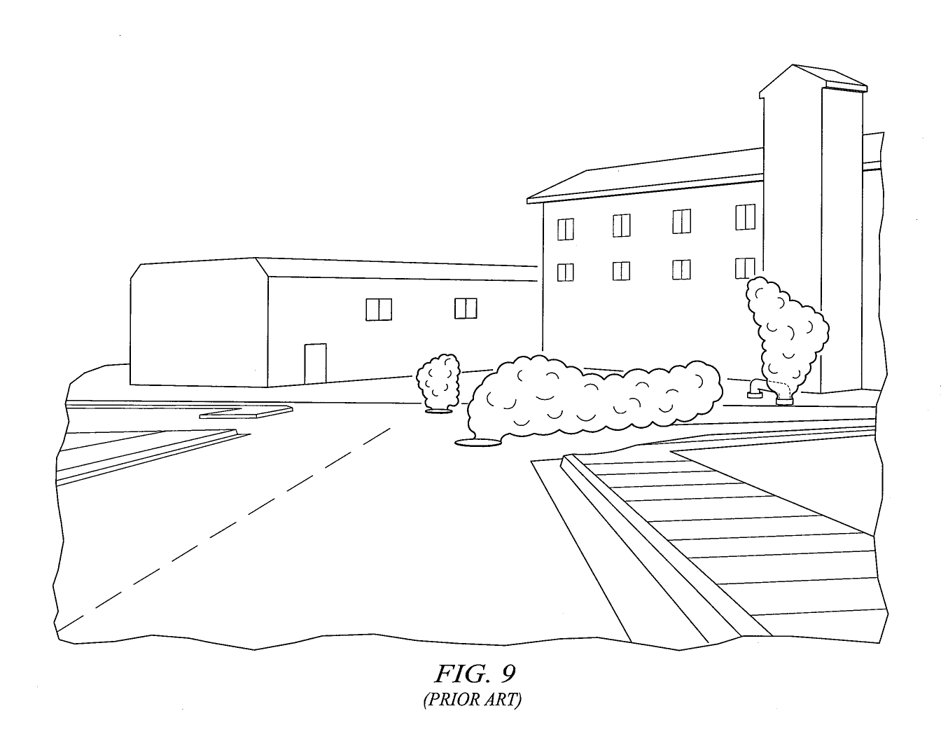

With reference first to FIGS. 7 and 8 of the drawings, one attempted solution for the problem of flooding manholes is to place the valve location above ground. FIGS. 7 and 8 show two such typical installations on a military base. While such installations may be acceptable, for example within the rather confined environment of a military installation, they would not be accepted in many other urban environments, simply because they are unattractive. The exposed nature of the valves also makes them vulnerable to vandalism or even sabotage.

The illustration shown in FIG. 9 is taken from a photograph of a typical manhole on a city street where the manhole has flooded and is blowing boiling steam. The Table which follows on the next page provides an estimate of the monthly costs associated with this type of boiling manhole situation:

MONTHLY COSTS IN ENERGY LOSSES ALONE FOR MANHOLES LEFT BOILING
THESE CALUCLATIONS DO NOT INCLUDE COSTS ASSOCIATED WITH REPAIR
OF DAMAGE OF EQUIPMENT

| Design | Operating Temp (° F.) | 331.00 | 335.00 | 338.00 | 353.00 | 366.00 |
|---|---|---|---|---|---|---|
| Criteria | Operating Pressure (PSIG) | 90.00 | 95.00 | 100.00 | 125.00 | 150.00 |
| | Total Pipe Length (FT) | 15.00 | 15.00 | 15.00 | 15.00 | 15.00 |
| | Carrier Pipe OD (FT) | 0.65 | 0.65 | 0.65 | 0.65 | 0.65 |
| Energy | High Velocity (BTU/Hr) | 1.42E+06 | 1.50E+06 | 1.58E+06 | 1.97E+06 | 2.36E+06 |
| Loss | Medium Velocity (BTU/Hr) | 1.39E+06 | 1.47E+06 | 1.55E+06 | 1.93E+06 | 2.31E+06 |
| | Low Velocity (BTU/Hr) | 1.35E+06 | 1.43E+06 | 1.50E+06 | 1.87E+06 | 2.24E+06 |
| Energy Rate | 7 $/MBTU | | | | | |
| Cost Per | High Velocity (262 ft/s) | $7,279.01 | $7,677.21 | $8,075.10 | $10,060.37 | $12,039.69 |
| Month | Medium (205 ft/s) | $7,125.56 | $7,515.12 | $7,904.37 | $9,846.34 | $11,782.27 |
| | Low (180 ft/s) | $6,922.11 | $7,300.47 | $7,678.52 | $9,564.58 | $11,444.69 |

Calculations have been made using equations and values developed for USACERL (United States Army Corp of Engineers Research Labs) Technical Report 98/62.

It will be appreciated from the above Table that the analysis basically yields a result of $8K per month in energy costs alone for a manhole with 6 inch pipe operating around 338 degrees F.

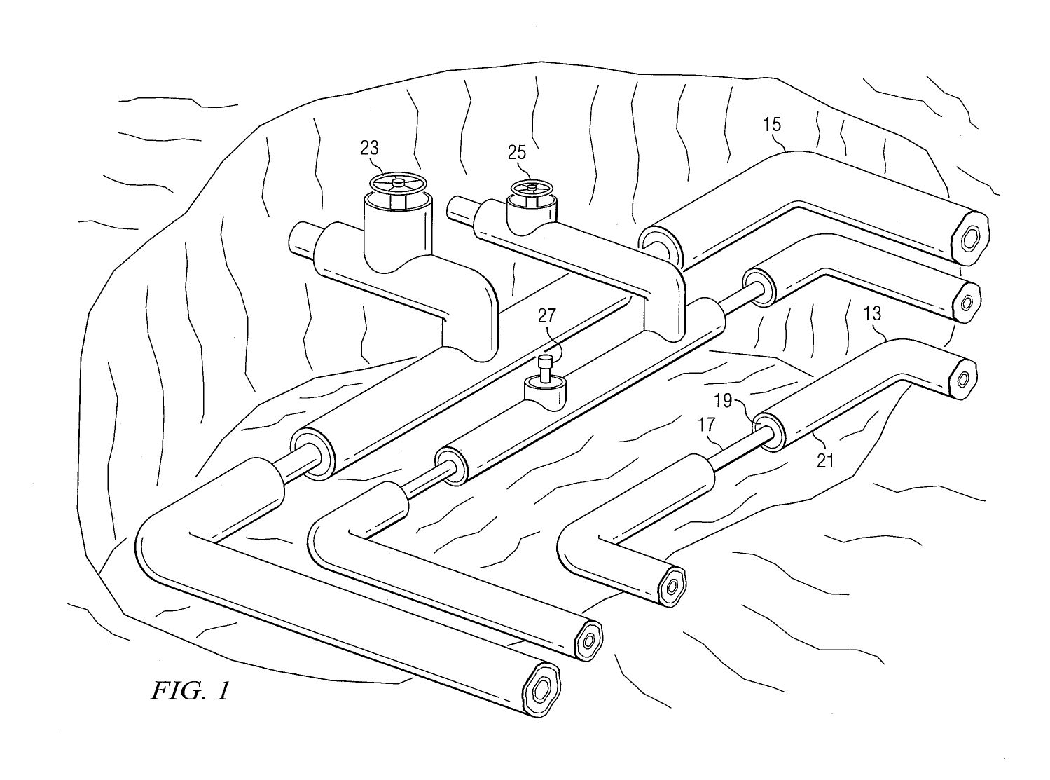

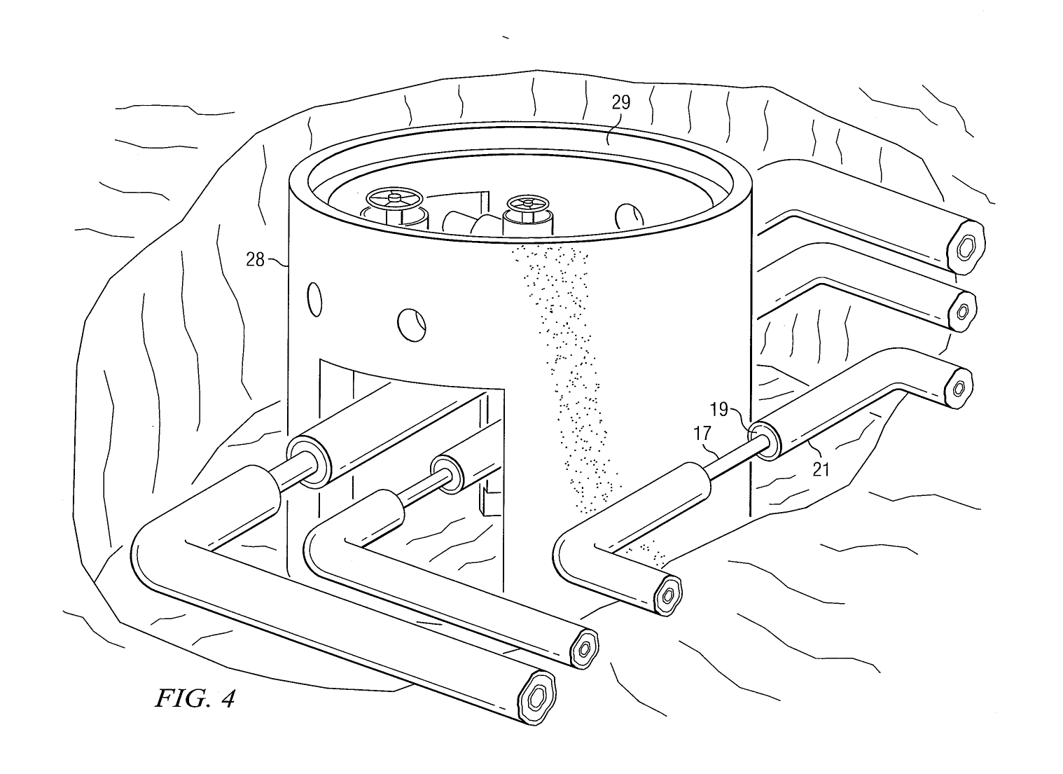

The present invention is a system for eliminating the need for watertight manholes in a pre-insulated piping system, thereby eliminating the various shortcomings in the prior art discussed above. The system of the invention can conceivably be used with a variety of types of pre-insulated piping. However, the typical installation will include a number of coaxially oriented lengths of pipe, such as length 13 (shown broken away in FIGS. 1-4). The installation may also include a number of angled fittings such as the right angle elbows (generally shown as 15) in FIG. 1. As perhaps best seen in FIG. 4, each length of pipe includes an inner pipe 17, typically formed of steel, an envelope of foamed insulation 19 surrounding the inner pipe and outer protective jacket 21 surrounding the envelope of insulation. The joining ends (shown generally in the region at 17 in FIG. 4) of adjacent pipe lengths are affixed, as by being welded together, to form fixed joints, whereby the adjacent pipe lengths provide a continuous fluid conduit for conveying high temperature fluids. The jacket 21 (FIG. 4) is typically formed of high density polyethylene (HDPE) or a similar polyolefin type material. The following references, among others, teach the manufacture of such prior art systems: U.S. Pat. No. 3,793,4111; U.S. Pat. No. 4,084,842; and U.S. Pat. No. 4,221,405, all to Stonitsch et al.

The reference in this discussion to pipe “lengths” is intended to refer to standard available factory pre-insulated piping of the type previously described having an inner metal pipe surrounded by an envelope of foamed insulation, which in turn, is contained within a polyolefin jacket. As referred to briefly above, typical commercial practice involves the use of steel, copper, aluminum or alloy conveying pipes, open or closed cell polyurethane, polyisocyanurate, polystyrene or the like, foamed rigid insulation and polypropylene, polybutylene, polyethylene, polyvinylchloride and similar protective jackets.

The term “high temperature”, as used in this discussion, will generally be any temperature exceeding 250 degrees F., which is the present temperature limitation at which polyurethane foam is used in bonded foam systems. Temperatures above 250 degrees F. require the use of higher temperature foams, such as polyisocyanurate foam.

Prior art pre-insulated piping of this general type are commercially available as standard factory type product. For example, such product is available from Thermacor Process, LP of Fort Worth, Tex., assignee of the present invention. One typical example is sold commercially as the HT-406 High Temp Steel Piping System. The published specifications for such systems are as follows:

### Carrier Pipe—

| | |
|---|---|
| diameter less than about 2″ | A53 ERW Grade B, Std. Wt. Black Steel |
| diameter greater than about 2″ | A106 SML, Std. Wt. Black Steel |

### HDPE Jacket—

Compatible with ASTM D3350

| | |
|---|---|
| Specific Gravity (ASTM D792) | 0.941 min. |
| Tensile Strength (ASTM D638) | 3100 psi min. |
| Elongation Ultimate (ASTM D638) | 400% min. |
| Compressive Strength (ASTM D695) | 2700 psi min. |
| Impact Strength (ASTM D256) | 2.0 ft. lb/in. North Min. |
| Rockwell Hardness (ASTM D785) | D60 (Shore) min. |

### Polyisocyanurate Insulation—

Density [symbol] 2.4 lbs/ft³
“K” Factor ≦0.14 @ 70 degrees F., ≦0.24 @ 406 degrees F.

### Compressive Strength 30 psi

### Closed Cell Content ≧90%

Minimum Thickness ≧2.5″ @ 366 degrees F., ≧3.0″ @ 406 degrees F.

The point at which two lengths of pre-insulated pipe are joined (as by welding) will typically have a layer of high temperature insulation surrounding the joining ends of the inner pipes (shown generally at 17 in FIG. 4). The layer of high temperature insulation can comprise a polyurethane foam for systems under 250 degrees F. or a polyisocyanate foam for systems above 250 degrees F. In some cases, it is possible to place a hollow jacket about the pipe joining ends 35, 37 with a two part commercially available mix being added through a hole in the jacket and allowed to cure. Alternatively, the insulating layer for the joining ends of the pipe is preformed at the factory and provided as two side half cuts which are placed about the pipe joining ends to form a concentric cylinder.

Turning now to FIGS. 1-4 of the drawings, there is illustrated the present system for eliminating watertight manholes in a pre-insulated piping system made up of lengths of high temperature insulated piping buried in a surrounding earthen formation. As will be appreciated from FIG. 1, a plurality of lengths of pre-insulated piping (such as the length 15 in FIG. 1) are sealingly connected in a pipeline to form a continuous fluid conduit for conveying high temperature fluids. The lengths of piping have been pre-insulated at the factory and the joints between the joining ends of the pipe lengths have been welded and surrounded by high temperature insulation, as well.

As is shown in FIG. 1, there is at least one valve location in the pipeline that contains at least one valve component, such as the valve stems 23, 25 located at a given height relative to a surrounding grade level. In this case, unlike the prior art, the valve location with its at least one valve component is also pre-insulated. This can be accomplished at the factory by using techniques similar to those described for insulating the joint between sections of piping. A previously insulated pipe joint containing the required valve component can then be supplied on site and joined in a length of the existing pre-insulated pipeline. FIG. 1 illustrates two valve stems installed within a pipe joint which makes up a part of a steam line and a condensate line, respectively. In any steam line installation of the type under consideration, steam condensate must be taken into consideration. The installation shown in FIG. 1 includes a commercially available “below grade drip tee” riser (generally at 27). These components are commercially available from Thermacor Process, LP, of Fort Worth, Tex.

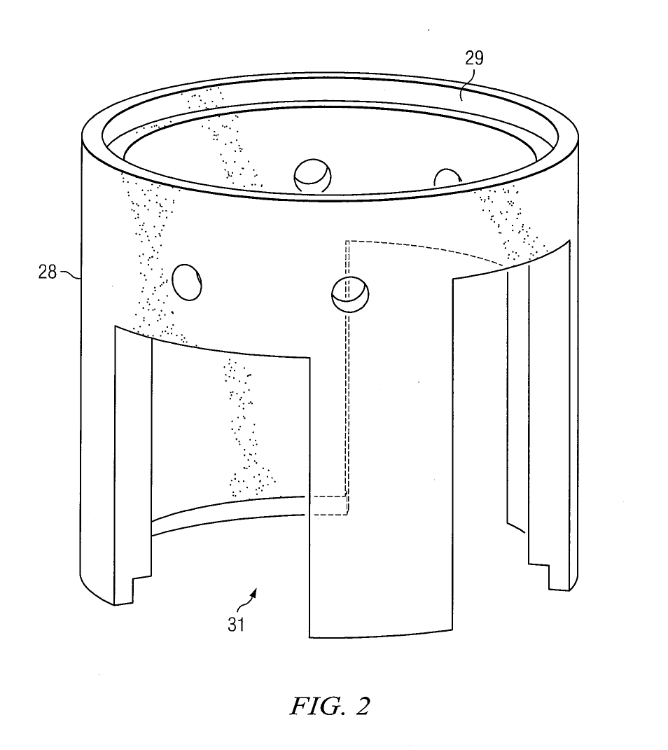

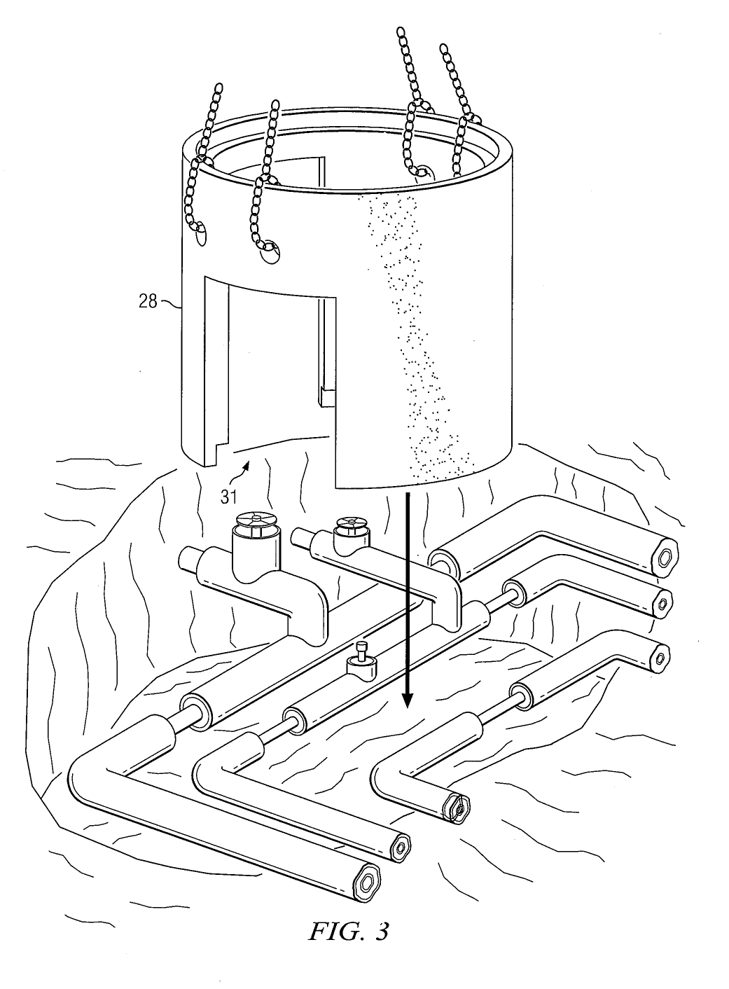

The system for eliminating the need for watertight manholes of the invention also includes some type of previously formed containment structure arranged about the valve location. The purpose of the containment structure is to hold the surrounding earthen formation in place away from the valve components. In the system of the invention illustrated in FIG. 2-4, the containment structure 28 is a concrete culvert which has been turned vertically on end and which has various openings cut therein to allow the entry and exit of pipes and other components. FIGS. 3 and 4 show the containment structure being lifted by a crane and set down upon the valve location so as to contain the valves and fittings which may be present. The containment structure has an initially open top 29 to allow access to an interior thereof. The open top will typically be fitted with a removable cover (not shown) of concrete, or other suitable material. It is also important to note that the containment structure 28 has an open bottom 31 with the structure simply sitting on the surrounding earthen grade. Because the piping and valve location have been pre-insulated at the factory, it is not critical that the interior of the containment structure be watertight. The primary purpose of the containment structure is simply to prevent dirt from caving into the valve location and covering the valves and fittings which may be present.

While the invention has been described with respect to a concrete containment structure 28, it will be appreciated that the structure could be made of other convenient materials such as steel, or perhaps even a molded plastic. The shape of the structure is not particularly critical and a square or rectangular shape might be more practical, depending upon the particular valve location.

As perhaps can be best appreciated from FIGS. 1 and 4, the height of the valve stems 23, 25 are selected, relative to the surrounding grade level, so that the respective valve stem is above a water table level for the surrounding earthen formation but at a convenient height for a maintenance worker to access within the interior of the containment structure.

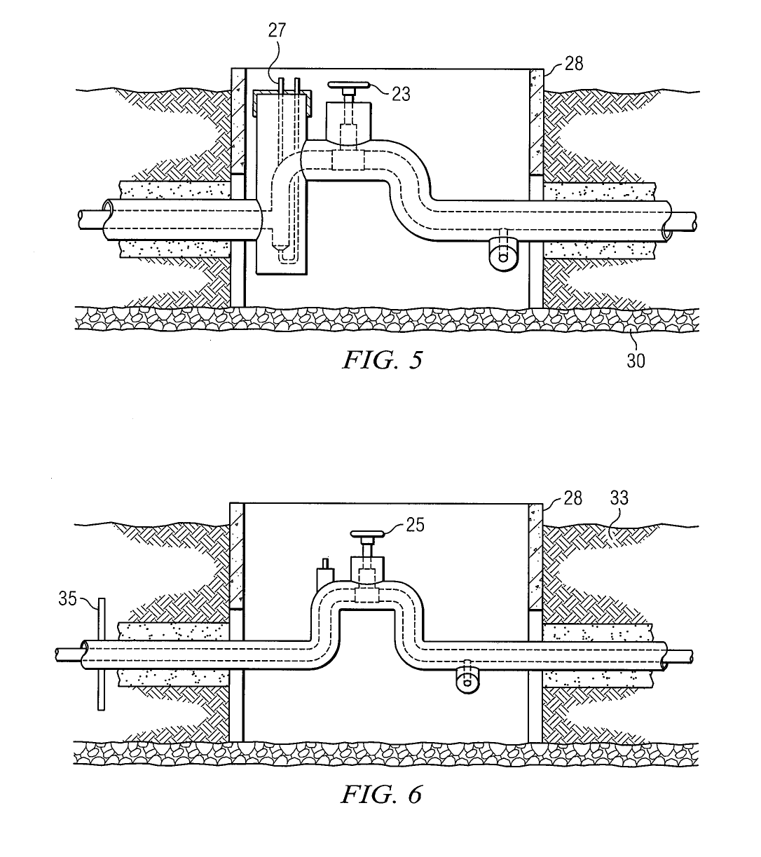

FIGS. 5 and 6 are side elevational views of the valve location, showing the relative height of the valve stems within the containment structure and with respect to the surrounding earthen grade (33 in FIG. 6). The interior of the containment structure 28 may be filled to a convenient level with a fill material, such as crushed stone (shown at 30 in FIG. 5). FIG. 5 also illustrates certain details of the “drip tee” riser 27 which is used to drain condensate at the low point in the line.

The present invention goes a long way toward eliminating concerns and requirements for confined space regulations in the relevant industries under consideration. A “confined space” is generally defined as an area that is subject to one or more of the following conditions:
1. Hazardous air (atmosphere);
2. A material that might engulf the entrant as it shifts or gives way;
3. An internal structure that could cause an entrant to be trapped or asphyxiated by inwardly converging walls or a floor which slopes downward and tapers to a smaller cross section;
4. Any other safety or health hazard.

The system of the invention eliminates many of the above concerns by bringing all of the devices or components of the valve station that require maintenance to near grade levels. This is particularly true of steam systems where there is always a need for an access point at the low points in the piping.

It will also be appreciated that the valve location and containment structure will typically be a location which is at the top of a loop in the piping system, or after an insulated underground in-line anchor (such as anchor 35 in FIG. 6). As a result, there will not be any necessity for a terminating hot end in a manhole as was often the case with the prior art installation techniques. In the system of the invention, the entire piping system is provided by the contractor whereas in the past, the piping system typically just went up to the manhole.

The present invention provides an improved method for providing access to a valve location in a pre-insulated piping system which also eliminates the need for a watertight manhole in the piping system, where the pre-insulated piping system is made up of lengths of high temperature insulated piping buried in a surrounding earthen formation. In the installation method of the invention, a plurality of lengths of pre-insulated piping are connected in a pipeline to form a continuous fluid conduit for conveying high temperature fluids, as previously described. A valve location is provided in the pipeline which contains at least one valve component located at a given height relative to a surrounding grade level. The valve location with its at least one valve component is also being pre-insulated. A previously formed containment structure is then placed in a position arranged about the valve location in order to hold the surrounding earthen formation in place away from the valve component. The containment structure has an initially open top to allow access to an interior thereof and an open bottom. A removable cover will typically be placed over the top of the containment structure until access is needed to the interior of the structure.

An invention has been provided with several advantages. The system of the invention incorporates several existing, commercially available materials or components, thereby simplifying manufacture and assembly. The component parts used in the system are simple in design and economical to implement in a variety of locations. The system of the invention entirely eliminates the need for watertight manholes, since the piping and valve locations are all factory pre-insulated. It is no longer critical that ground water or rain water be kept completely out of the interior of the surrounding structure. In fact, no attempt is made to keep the containment structure completely watertight. If water does contact the valves and fittings present at the valve location, it is no longer a catastrophic event. The location of the valve components such as the valve stems is intentionally placed as close to the top of the surrounding grade as is practical and convenient, i.e., out of the water table. This means that the contractor performing maintenance work will often be standing only about waist high in the interior of the containment structure while performing work. This is especially convenient when the work involves, for example welding in the interior space of the containment structure. A suitable media such as crushed rock may be placed within the interior of the containment structure up to a level just below the valves.

While the invention has been shown in one of its forms, it is not thus limited but is susceptible to various changes and modifications without departing from the spirit thereof.

What is claimed is:

1. A system for eliminating watertight manholes in a pre-insulated piping system made up of lengths of high temperature insulated piping buried in a surrounding earthen formation, the system comprising:
a plurality of lengths of pre-insulated piping sealingly connected in a pipeline to form a continuous fluid conduit for conveying high temperature fluids;
a valve location in the pipeline containing at least one valve component located at a given height relative to a surrounding grade level, the valve location with its at least one valve component also being pre-insulated;
a previously formed containment structure arranged about the valve location to hold the surrounding earthen formation in place away from the valve component, the containment structure having an initially open top to allow access to an interior thereof;
a removable cover for the open top of the containment structure;
wherein the pre-insulated piping and valve location eliminates the need for a watertight manhole while providing improved access to the valve location.

2. The system of claim 1, wherein the valve component is selected from the group consisting of valve stems and fittings.

3. The system of claim 1, wherein the lengths of high temperature insulated piping which make up the piping system each include a first and second length of inner metal carrier pipe, each having an inner end and an opposite, outwardly extending end, the first and second lengths of metal pipe being surrounded by an envelope of bonded foamed insulation, the foamed insulated, in turn, being surrounded by an outer protective jacket, and wherein the outwardly extending end of each of the first and second lengths of metal carrier pipe projects beyond an end of the envelope of insulation and beyond an end of the jacket to form an exposed, joining end, the joining ends of the inner pipes being sealingly connected in the piping string to form the continuous fluid conduit for conveying high temperature fluids.

4. The system of claim 3, wherein the foam insulation is selected from the group consisting of polyurethane foams and polyisocyanurate foam.

5. The system of claim 3, wherein the protective jackets are formed from a synthetic polyolefin.

6. The system of claim 3, wherein the lengths of insulated piping being joined are part of a pipeline conveying steam, hot water or other hot fluids.

7. The system of claim 1, wherein the height of the valve stem is selected, relative to the surrounding grade level, so that the valve stem is above a water table level for the surrounding earthen formation but at a convenient height for a maintenance worker to access.

8. The system of claim 7, wherein the piping installation includes, in addition to a steam line conveying steam, a condensate line for draining steam condensate, the condensate line having a below grade drip tee incorporated therein, and wherein the condensate line and drip tee are also pre-insulated.

9. A method of providing access to a valve location in a pre-insulated piping system which also eliminates the need for a watertight manhole in the piping system, the pre-insulated piping system being made up of lengths of high temperature insulated piping buried in a surrounding earthen formation, the method comprising:
connecting a plurality of lengths of pre-insulated piping in a pipeline to form a continuous fluid conduit for conveying high temperature fluids;
providing a valve location in the pipeline containing at least one valve stem located at a given height relative to a surrounding grade level, the valve location with its at least one valve stem also being pre-insulated;
placing a previously formed containment structure in a position arranged about the valve location in order to hold the surrounding earthen formation in place away from the valve stem, the containment structure having an initially open top to allow access to an interior thereof and an open bottom;
placing a removable cover over the top of the containment structure until access is needed to the interior of the structure.

10. The method of claim 9, wherein each of the lengths of high temperature insulated piping in the pipeline also comprises a metal inner carrier pipe surrounded by a layer of bonded foam insulation which, in turn, is surrounded by an outer protective jacket.

11. The method of claim 10, wherein the foam insulation which is used to surround the inner pipes is selected from the group consisting of polyurethane foam and polyisocyanurate foam.

12. The method of claim 11, wherein the protective jackets are formed of HDPE.

13. The method of claim 12, wherein the lengths of insulated piping being joined are part of a pipeline conveying steam at a temperature of 400 degrees F. or less.

14. The method of claim 13, wherein the interior of the containment structure is filled with a selected media to a level below the height of the valve stem.

15. The method of claim 14, wherein the media is stone.

16. The method of claim 9, wherein the containment structure has a construction selected from the group consisting of concrete, a molded synthetic plastic and metal.
